(19) United States
(12) Patent Application Publication
(10) Pub. No.: US 2008/0035687 A1
(43) Pub. Date: Feb. 14, 2008

(54) Package Support Utilizing Elastically Adaptable Tension

(76) Inventor: Andrew Beaulieu, Rockville, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/837,297

(22) Filed: Aug. 10, 2007

Related U.S. Application Data
(60) Provisional application No. 60/837,302, filed on Aug. 14, 2006.

(51) Int. Cl. B60R 7/04

(52) U.S. Cl. 224/275

(57) ABSTRACT

An elastically resilient support for one or more packages being transported on a motor vehicle passenger seat includes an elastic band and a fastening member adapted to engage the handles of the supported package. The band suspended from a location proximate the top of the backrest of the passenger seat for applying an upward resilient force on the supported package while maintaining the bottom of the package on the seating portion. The elasticity of the band and its configuration prevent it from returning to its quiescent unstretched shape as long the package is engaged.

### CROSS REFERENCE TO RELATED APPLICATION

This application claims priority from my U.S. Provisional Patent Application Ser. No. 60/837,302 entitled “Package Support for Use in Motor Vehicles,” filed Aug. 14, 2006. The disclosure of this provisional patent application is incorporated herein by reference in its entirety.

### FIELD OF THE INVENTION

The present invention pertains to package supports and, in particular, to supports used for shopping bags, and the like, in motor vehicles to prevent the bags from falling over or off a passenger seat.

### BACKGROUND

It is common for drivers of vehicles, for purposes of convenience, to transport grocery and food carry-out shopping bags, and the like, on a passenger seat of their vehicles. Shopping bags thusly transported often fall over or off the seat, spilling their contents, in response to certain vehicle motions, such as turns, stops, deceleration, etc. Apart from the undesirability of having the package contents spill on the vehicle seat and floor, the moving packages present a safety hazard by tending to distract the driver.

This problem has been addressed, with varying degrees of success, in the prior art by taking advantage of the fact that most shopping bags have opposed handle portions at their upper ends. Several prior art shopping bag supports utilize straps or belts that attach to the headrest structure of a vehicle seat. For example, in Japanese Publication No. 2001347891 there is disclosed a strap with hooks at each end adapted to attach to respective headrest support posts. The strap may either be extended through the bag handles before attachment to the headrest posts, or may be provided with another hook at the longitudinal center of strap for engaging the bag handles. This type of arrangement functions properly only for bags having a narrow range of lengths or heights. If the bag is too tall the strap will not exert much upward force, resulting in the bag not being firmly held and being subject to tilting and spillage of contents in response vehicle motion. If the bag is too short it will be lifted off the seat and likely to swing about in response to vehicle motion. Other shopping bag supports attach to the vehicle seat or headrest and suffer from the same or similar problem. Furthermore, many of them suffer from additional disadvantages, such as the need to disconnect the support when not in use to enable a passenger to comfortably sit in the vehicle seat, time consumption in connecting the support to and disconnecting it from the vehicle seat structure, time consumption in connecting the support to the shopping bag, etc.

### SUMMARY OF THE INVENTION

In accordance with the present invention a shopping bag support is attached about a vehicle seat headrest and is maintained in resilient tension while in use such that the bottom of the bag remains in contact with the vehicle seat cushion, a bag side remains in contact with the seat backrest, and the bag handles are resiliently pulled upward. The resilient tension permits the support to be used with bags having a wide range of heights. The combination of (a) the frictional force resisting movement of the bag bottom along the seat cushion surface, (b) the frictional force resisting movement of the bag along the seat backrest and (c) the upward vertical tension force acting on the bag handles, results in a firm engagement of the shopping bag to prevent against both sliding and tilting.

In the preferred embodiment the bag support includes a resilient band in the form of an endless loop of elastomeric material that is disposed around the headrest or the headreast support posts, and is suspended a short distance down along the seat backrest. An easily engaged bag fastening member, preferably a strip of hook and eye fastening material (e.g., Velcro™), is secured to the resilient band. When one or more shopping bags are placed on the vehicle seat cushion, the vehicle driver secures the fastening member about the shopping bag handles. The circumference of the resilient band is sufficiently short that that the band must be stretched downward to permit the fastening member to be extended to and engage the handles of substantially any size shopping bag. Once the bag handles are engaged by the fastening member, the band applies an upward resilient force on the bag. The elasticity of the band and the band circumference are such that the band cannot return to its quiescent or unstretched shape as long as a shopping bag is engaged, but the shopping bag is not lifted entirely from the seat cushion.

In another embodiment the bag support is permanently attached to a handle of a re-useable shopping bag of canvas or other durable material. In such case the resilient band must be deployed over the top of the vehicle backrest or headrest while contents are in the bag.

The above and still further features and advantages of the present invention will become apparent upon consideration of the following definitions, descriptions and descriptive figures of specific embodiments thereof wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a view in perspective of a first preferred embodiment of a shopping bag support according to the present invention showing the bag fastening strip in its open position.

FIG. 2 is a view in perspective of the embodiment of FIG. 1 showing the bag fastening strip in its closed position.

FIG. 3 is a view in perspective showing the embodiment of FIG. 1 deployed on a vehicle seat headrest.

FIG. 4 is a view in perspective showing the embodiment of FIG. 1 deployed as in FIG. 3 with an unsecured shopping bag on the vehicle seat.

FIG. 5 is a partially diagrammatic view in perspective showing the embodiment of FIG. 1 deployed as in FIG. 4 and being secured to the shopping bag.

FIG. 6 is a view in perspective showing the embodiment of FIG. 1 deployed as in FIG. 5 with the shopping bag fastened thereto.

FIG. 7 is a view in perspective of the embodiment of FIG. 1 showing the bag fastening strip in its closed position and with logo indicia imprinted on the fastening strip.

FIG. 8 is a view on perspective of a second embodiment of a shopping bag support according to the present invention with the fastening strip permanently secured to a shopping bag handle.

FIG. 9 is a view on perspective of a third embodiment of a shopping bag support according to the present invention wherein a clip is secured to the fastening strip.

FIG. 10 is a view on perspective of a fourth embodiment of a shopping bag support according to the present invention wherein the fastening strip is immovably secured to the elastic band.

### DESCRIPTION OF THE PREFERRED EMBODIMENTS

The following detailed explanations of the drawings and of the preferred embodiments reveal the methods and apparatus of the present invention.

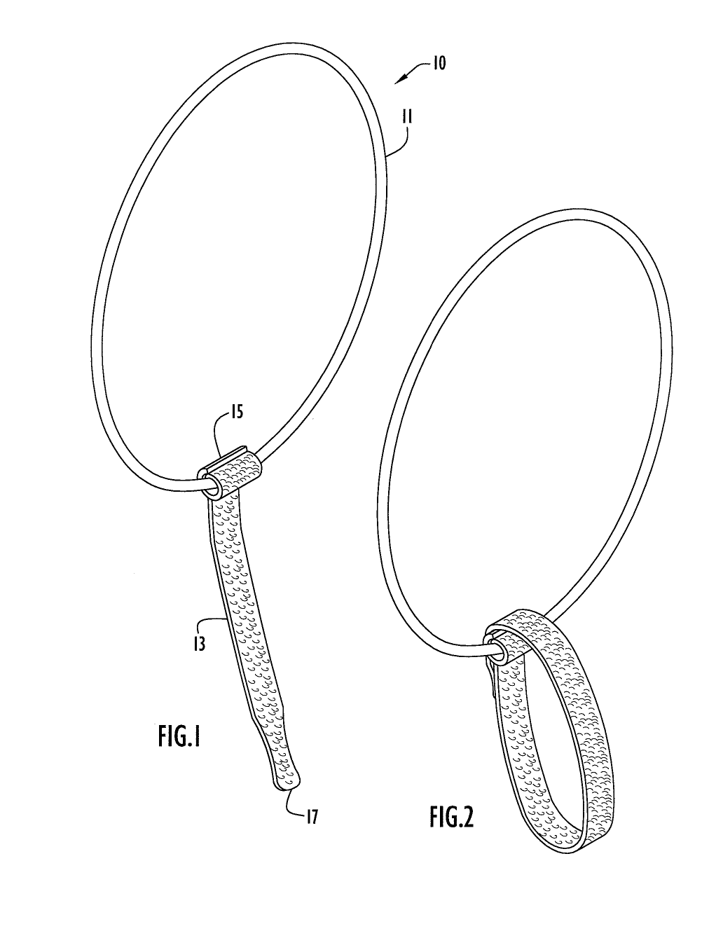

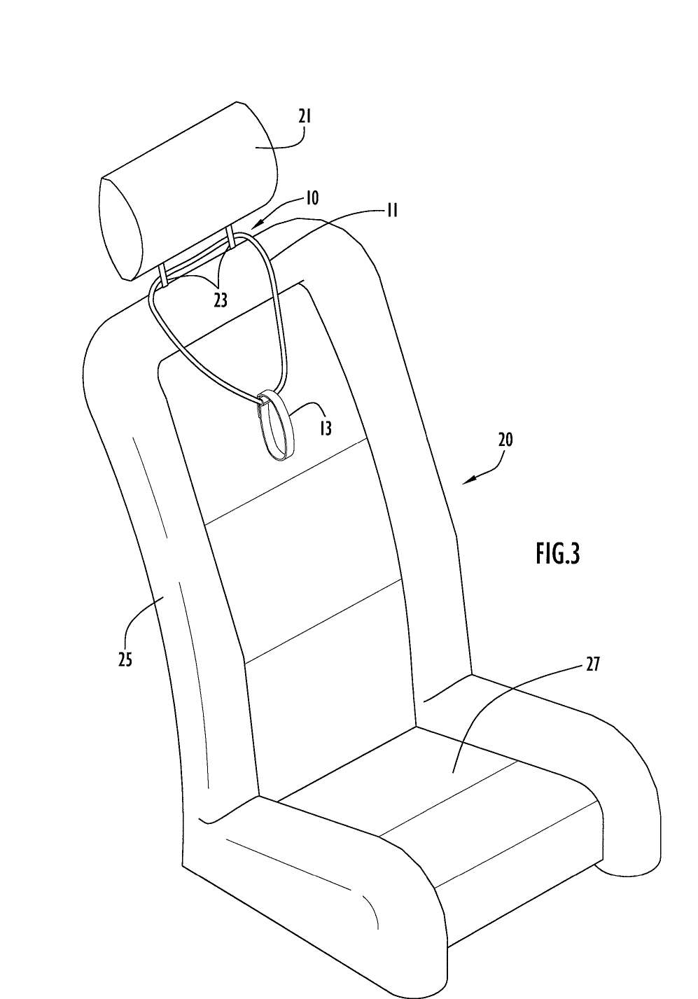

Referring specifically to FIGS. 1 and 2, a shopping bag support unit 10 according to a preferred embodiment of the present invention includes an elastic band in the form of an endless loop 11 having a bag-fastening member 13 secured thereto. In the preferred embodiment fastening member 13 is a flexible strip of hook and loop fastening material (i.e., Velcro™) having hook material on one surface and loop material on the opposite surface. The loop material is deployed on a layer of fabric material (typically formed from polymer fibers) to which a plastic layer bearing the hooks is adhesively secured. Fastening strip 13 has a slot defined therethrough at a proximal end 15 through which the distal end 17 of the strip is inserted and pulled to the maximum extent to thereby encircle a short length of band 11 and connect strip 13 to the band in concentric slidable relation. It will be understood that while this type of connection is preferred due to its simplicity, the connection between band 11 and strip 13 need not be movable along the band and can be effected in any other convenient manner. As illustrated in FIG. 2, strip 13 may form a fastening closure by forcing a portion of the hook material surface of distal end 17 against a portion of the loop material surface of proximal end 15.

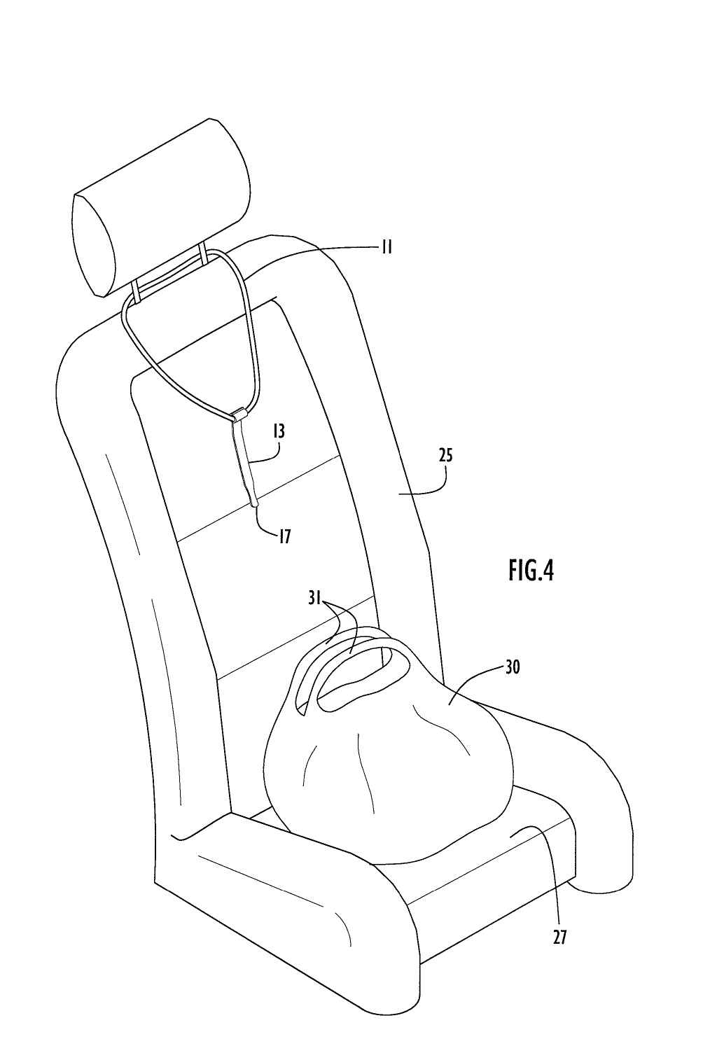

Referring to FIG. 3, unit 10 may be deployed on a vehicle passenger seat 20 by disposing band 11 over the seat headrest 21 so that the band is suspended from the headrest support posts 23. To achieve this position is it typically required that the band be stretched while being pulled over the headrest. In the deployed position band 11 hangs down, unstretched, along the front surface of the backrest 25, well spaced above the seat cushion 27. In this quiescent or ready condition, with strip 13 closed as shown, or open (as seen in FIG. 1), it is preferred that the lowermost portion of the dependent fastening member 13 be positioned at a location no more than one-third to one-half of the distance between seat cushion 27 and the top of the backrest 25. In the quiescent condition unit 10 is unobtrusive and, because of its flexibility, does not interfere with a passenger sitting in seat 20. Of course, unit 10 may be shifted to be suspended along the rear of backrest 25 so as to be entirely out of the way of the seated passenger.

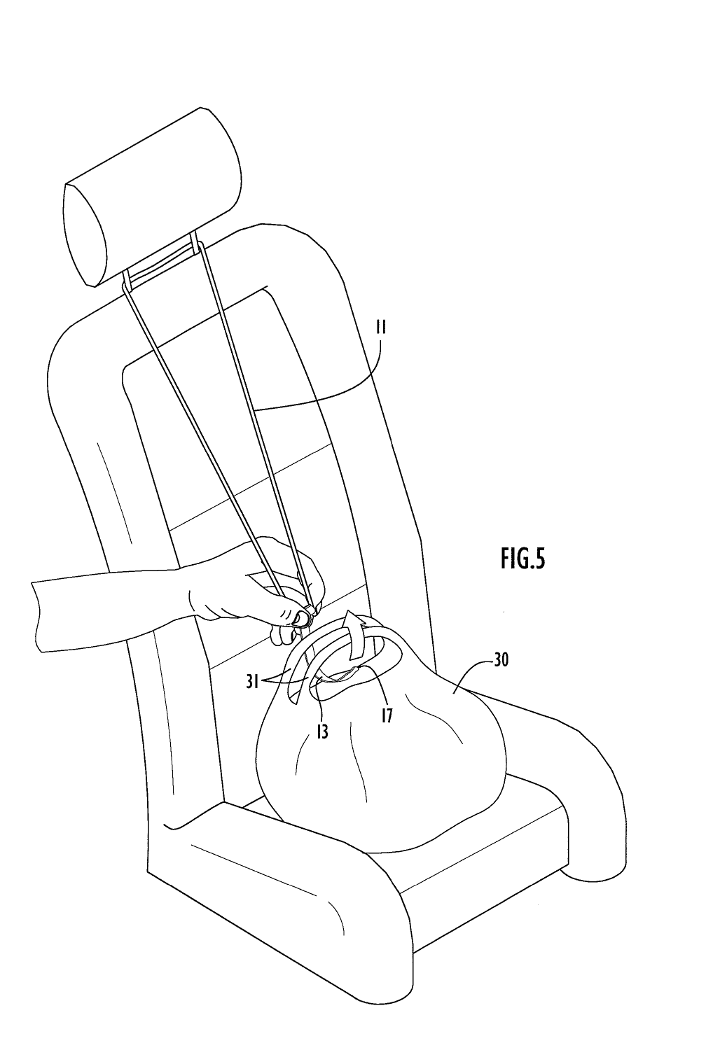

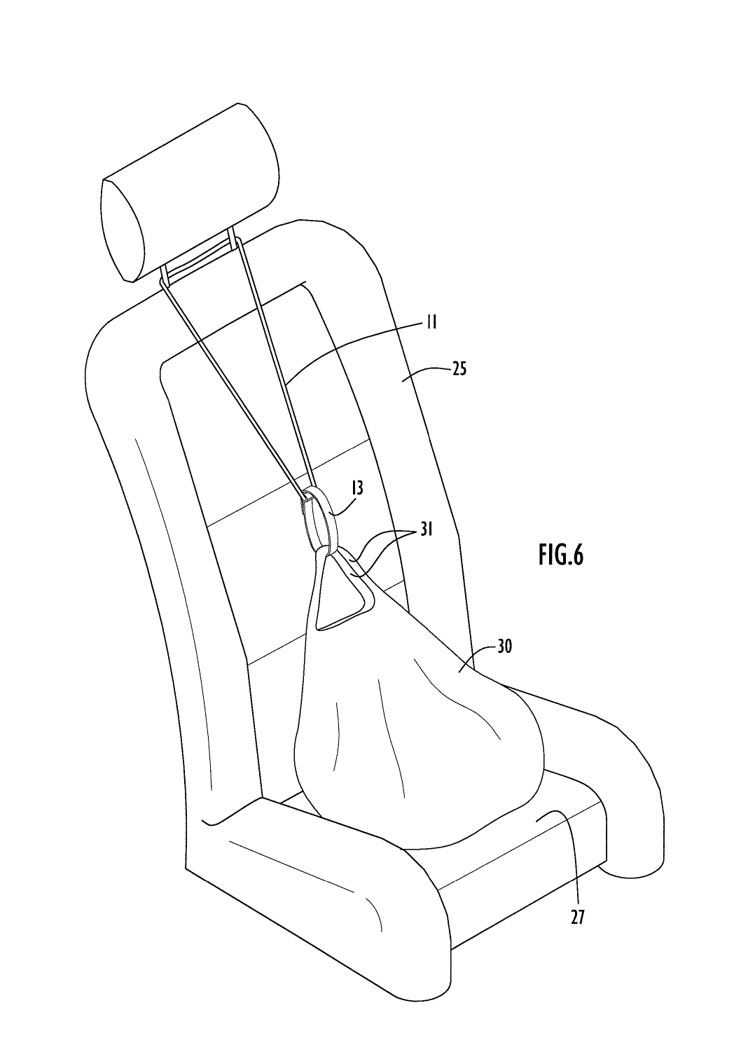

When one or more packages or shopping bags 30 to be supported are placed on seat cushion 27 as illustrated in FIG. 4, unit 10 is positioned with band 11 suspended along the front surface of backrest 25 with fastening strip 13 in its open condition. It is noted that the lowermost portion of suspended band 11, and the distal end 17 of strip 13, are disposed well above the seat cushion 27 and the top of the bag 30 where the bag handles 31 are located. Referring to FIG. 5, in order to engage and support bag 30, the driver or other person pulls down on band 11 at its lowermost portion to stretch the band until the distal end 17 of strip 13 can be inserted through bag handles 31. The thusly inserted distal end 17 is then turned back toward and pressed against the proximal end of strip 13 so that the hook material at the distal end engages the loop material at the proximal end. The result is a closed fastening loop formed by strip 13 about bag handles 31. The user then releases the stretched band 11 and, as shown in FIG. 6, the band tends to return toward its unstretched or non-tensioned state. In so doing, band 11 causes fastening strip 13 to pull the bag handles upward along the backrest 25. Shopping bag 30 is thereby held in vertical tension with the bag bottom disposed on seat cushion 27 and the rear of the bag disposed against the front surface of backrest 25. The bag is prevented from tipping by the resilient vertical tension force provided by elastic band 11. At the same time, frictional forces between bag 30 and seat cushion 27, and between the bag and the front surface of backrest 25, act to reduce any tendency of the bag to move laterally and forward relative to seat 20 during vehicle turns and sudden speed changes. Importantly, once the bag handles are engaged by the fastening member, the band 11 applies an upward resilient force on the bag. The elasticity of the band and the band downward length are such that the band cannot return to its quiescent or unstretched shape as long as a shopping bag is engaged, but the shopping bag is not lifted entirely from the seat cushion.

It is important that the combined lengths of elastic band 11 and strip 13, combined with the elasticity of band 11, be such that the supported shopping bag is held in tension but is not lifted off seat cushion 27. In this regard, and as noted above, the length of band 11 in its relaxed or quiescent state illustrated in FIGS. 3 and 4 be such that the lowermost portion of the suspend band be positioned above the bag handles 31.

By way of example, and without intention to limit the scope of the appended claims, the following dimensions, materials and properties are applicable to the preferred embodiments of the support unit. Band 11 is a preferably a cord-like member made of any material suitable for providing the elasticity required to effect the functional characteristics described herein. Examples of suitable materials would be rubber, plastic, silicone, polyester, nylon, etc., which may be integral or made of multiple twisted strands. The thickness or diameter of the cord-like member 11 is typically between ⅛″ and ½″. For a vehicle backrest on the order of 27″ high above the seat surface, and for a typical supported package height of between 12″ and 16″, the circumference of endless resilient band 11 is typically between 15″ and 25″ (optimally about 20″), and the length of strip 13 is typically between 5″ and 10″ (optimally about 8″) long and ½″ wide. The elasticity of the material of band 11 should be such that the band can stretch lengthwise by 160%+/−20% without permanent deformation. It will be appreciated that the total length of the suspended band 11 and strip 13 when the strip engages a bag or package, is somewhat adjustable by adjusting the lengths on strip 13 that are engaged in a hook and loop connection (i.e., by selecting the length of overlap of the distal end 17 on the proximal end 15). This permits the user to adapt the unit to bags or packages of different height and weight.

The relationship between the downward length of the unstretched band 11 and the permissible elastomeric tension of the band material is such that when the device is in use, the supported package(s) rest on the seat cushion. The tradeoff in these parameters will be appreciated in that, as the length of the band is decreased, the required elastomeric stretchability of the band must increase for a given length of strip 13.

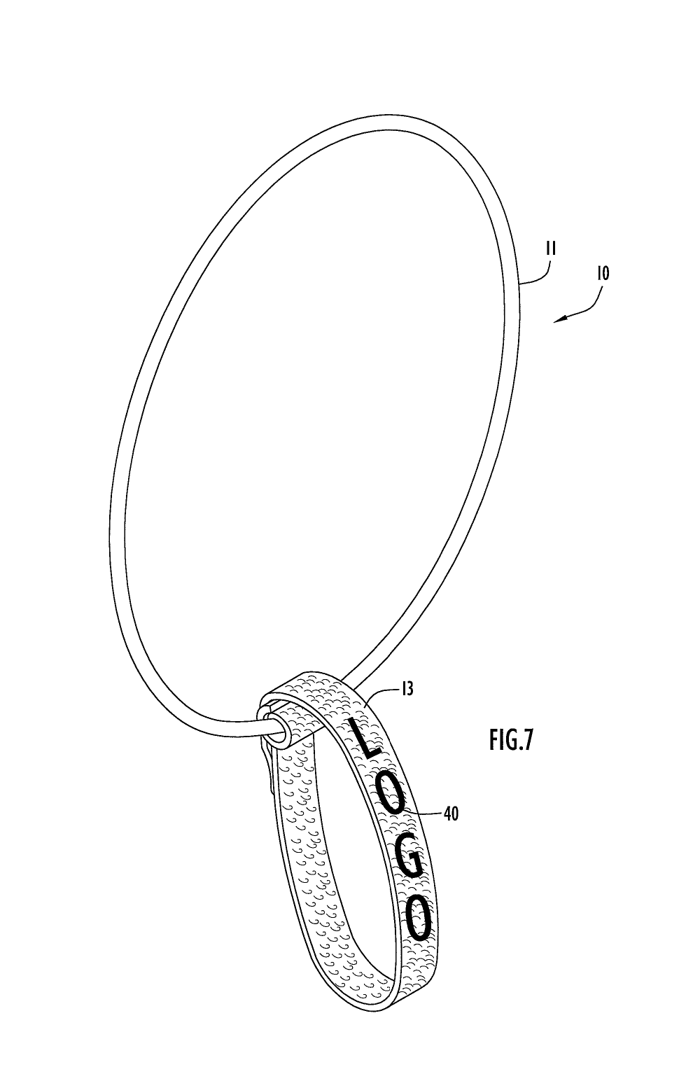

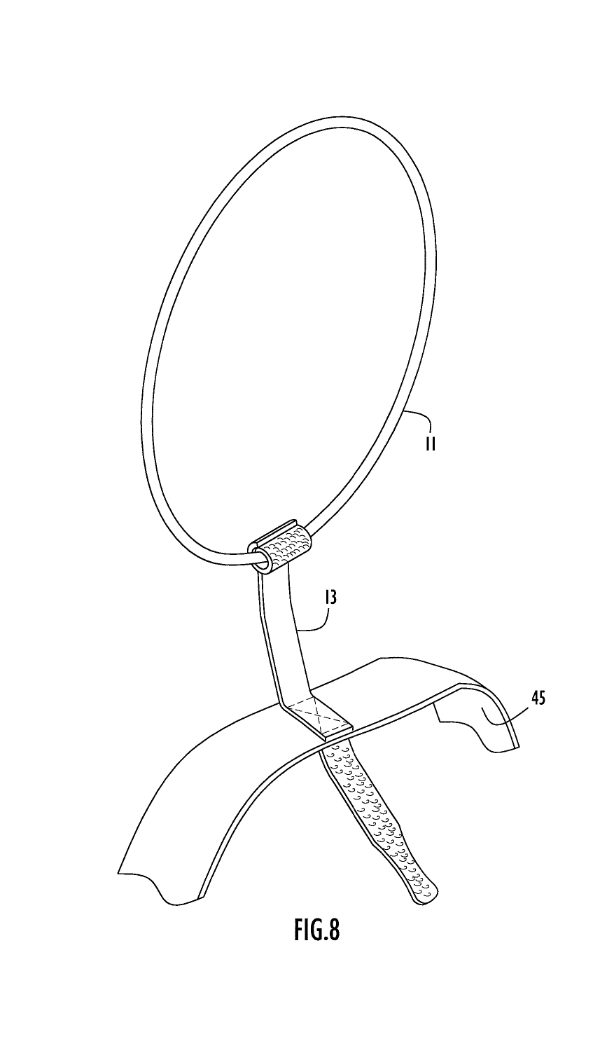

As illustrated in FIG. 7, it is a feature of the invention to permit printing 40, such as a company name and/or logo, on strip 13, particularly on the surface containing the softer loop material fabric. Units with such printing can serve as advertisements on units 10 that could be sold or given away to customers of grocery stores, carry-out establishments, and the like.

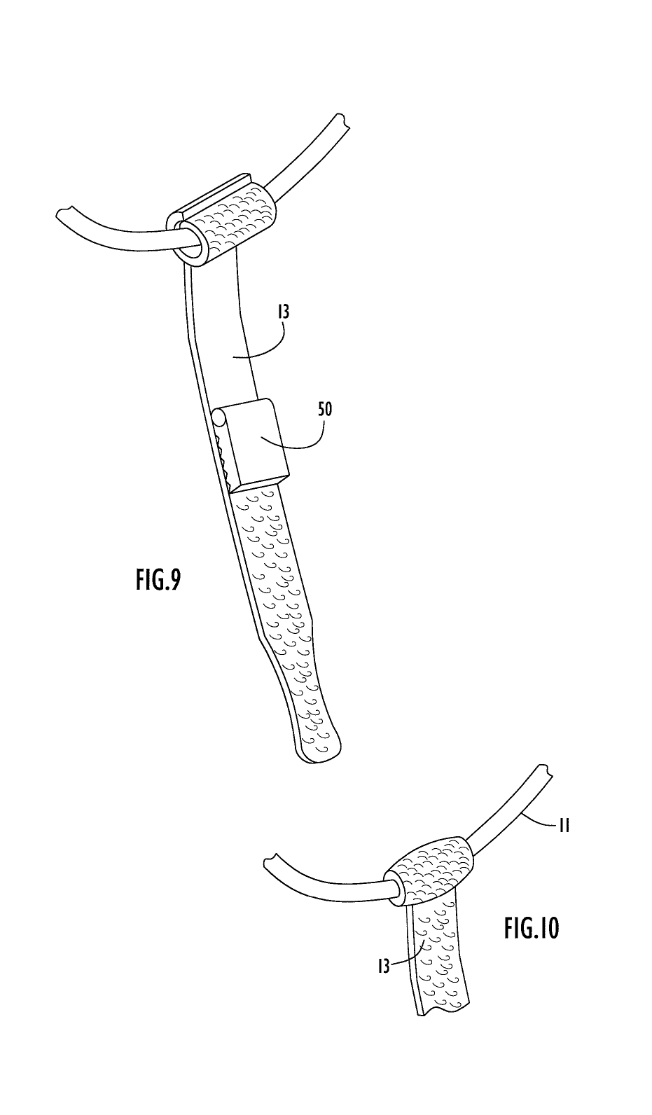

Strip 13 may be permanently attached to a flexible handle of a re-useable, typically canvas, shopping bag. This feature is illustrated in FIG. 13 wherein strip 13 is shown sewn to one handle 45 of such a shopping bag. To engage that bag when full, the user would extend the distal end of strip 13 around the other flexible bag handle and then attach the distal end of the strip to the proximal end in the manner described above. Instead of permanent attachment to the bag handle, a clip 50 may be secured to strip 13 (see FIG. 9) and used to selectively engage a bag handle.

The movability of the proximal end of strip 13 along band 11 is advantageous for re-positioning the strip. Nevertheless, as noted above, strip 13 may be immovably attached to band 11 by forming an annular member at the proximal end of the strip and securing it by adhesive or the like to the band.

In the preferred embodiments described herein, the fastening member is a strip having a connector of the type having hook material on one surface and loop material on the opposite surface. This type of fastening member has several advantages, including adjustable length to accommodate packages of different height, the ability to bear advertising or other design indicia, unobtrusiveness because it can be compresses to a relatively flat state and br unobtrusive for a passenger using the seat, etc. It should be noted, however, that it is within the scope of the present invention to use, in combination with an elastic band, any type of fastening member to support packages having handles in the manner described. Examples of alternative fastening members are hooks, clips, and other mechanisms and devices capable of lifting the handles of the bag when attached to an elastic band.

Also in the preferred embodiments the resilient band is an endless loop. It will be appreciated that the important aspect of the band is its resilience, and that a loop configuration is merely a preferred embodiment because of its convenience in use and deployment. Accordingly, the resilient band may be an elongated strip that can be wrapped about or otherwise secured to the headrest or headrest support posts at one end and wrapped or otherwise secured to the handles of the supported package at the other end. This configuration has the advantage of eliminating the separate fastening member, but is less convenient to deploy. Further, an elastically stretchable member of any configuration may be employed as long as it is capable of holding the supported package in vertical tension.

Although unit 10 can remain in place when not in use without interfering with passenger comfort, it can be easily stored in a vehicle glove compartment for out of sight storage.

Another advantage of support unit 10 is the extremely low cost of manufacture, typically well under one dollar.

If desired the band and strip can be provided in a color combination or scheme to match a favorite team or school. For example, the band can have a burgundy color; the strip can have a gold color.

Having described preferred embodiments of new and improved package support for use in motor vehicles, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in a generic and descriptive sense only and not for purposes of limitation.

What is claimed is:

1. A support for one or more packages being transported on a motor vehicle passenger seat, the packages being of the type having handles at the top of the package, said support comprising:
an endless stretchable elastic band adapted to be suspended from a location proximate the top of the backrest of the passenger seat; and
a fastening member secured to said elastic band and adapted to engage the handles of the supported package.

2. The support of claim 1 wherein said fastening member is of the hook and loop type comprising a strip having hook material on one surface and loop material on an opposite surface.

3. The support of claim 2 wherein said band is in the form of an endless loop adapted to be suspended from a headrest for said passenger seat.

4. The support of claim 3 wherein said fastening member bears advertising indicia.

5. The support of claim 2 wherein said band is in the form of an endless loop and has a circumference when unstretched of between approximately 15 and 25 inches.

6. The support of claim 5 and wherein said strip has a length between approximately 5 and 10 inches.

7. The support of claim 6 wherein said band is capable of being stretched lengthwise by approximately 160%+/−20% without permanent deformation.

8. The support of claim 2 wherein, with said band unstretched, said fastening member is disposed along the backrest at a position no more than approximately half way between the top and bottom of the backrest.

9. The support of claim 2 wherein said fastening member is permanently secured to a bag handle by stitching, or the like.

10. The support of claim 1 wherein, when the fastening member engages the handles of a supported package, said band applies an upward resilient force on the supported package, and wherein the elasticity of the band and the band length are such that the band is prevented from returning to its quiescent unstretched shape as long the package is engaged, and the supported package is not fully raised above the seat portion of the passenger seat.

11. The support of claim 10 wherein said band is in the form of an endless loop adapted to be suspended from a headrest for said passenger seat, has a circumference when unstretched of between approximately 15 and 25 inches, and is capable of being stretched lengthwise by approximately 160%+/−20% without permanent deformation; and wherein, with said band unstretched, said fastening member is disposed along the backrest at a position no more than approximately half way between the top and bottom of the backrest.

12. A support for one or more packages being transported on a motor vehicle passenger seat, the packages being of the type having handles at the top of the package, said support comprising elastic means, including a fastening member adapted to engage the handles of the supported package, said elastic means adapted to be suspended from a location proximate the top of the backrest of the passenger seat for applying an upward resilient force on the supported package, and wherein the elasticity of the elastic means and its configuration are such that the band is prevented from returning to its quiescent unstretched shape as long the package is engaged.

13. The support of claim 12 wherein said fastening member is of the hook and loop type comprising a strip having hook material on one surface and loop material on an opposite surface, said strip being secured to said elastic means.

14. The support of claim 13 wherein said strip has a length between approximately 5 and 10 inches.

15. The support of claim 13 wherein said elastic means is an endless loop of stretchable material secured to said strip.

16. The support of claim 13 wherein said fastening member bears advertising indicia.

17. A method of supporting at least one package being transported on a motor vehicle passenger seat, the package being of the type having handles at the top of the package, said method comprising applying a resilient upward force on said handles to maintain the package in vertical tension while partially resting on the passenger seat seating portion and against the passenger seat backrest.
